(19) United States
(12) Patent Application Publication
(10) Pub. No.: US 2015/0097345 A1
(43) Pub. Date: Apr. 9, 2015

(54) SHAFT SEALING SYSTEM FOR A TURBOCHARGER

(71) Applicant: BorgWarner Inc., Auburn Hills, MI (US)

(72) Inventors: Timothy House, Hendersonville, NC (US); Daniel N. Ward, Asheville, NC (US)

(21) Appl. No.: 14/400,100

(22) PCT Filed: May 1, 2013
(86) PCT No.: PCT/US2013/038970

§ 371 Date: Nov. 10, 2014

Related U.S. Application Data
(60) Provisional application No. 61/648,163, filed on May 17, 2012.

(51) Int. Cl. F01D 25/18; F02B 39/16; F16J 15/16

(52) U.S. Cl. CPC F01D 25/186; F16J 15/16; F02B 39/16
USPC 277/585

(57) ABSTRACT

The propensity for gas and soot leakage around a shaft, which extends through a bore which connects volumes of differing pressures (e.g., a turbocharger turbine housing and the ambient air), is minimized by the addition of a complementary pair of narrowing sealing surfaces which provide a seal against the passage of said gases and soot. Such sealing surfaces can be frusto-spherical or frusto-conical. A biasing element is operatively positioned to exert biasing forces on one or more structures to maintain the sealing surfaces in engagement with each other to form a seal.

### FIELD OF THE INVENTION

Embodiments relate in general to turbochargers and, more particularly, the interface between a shaft and a housing in a turbocharger.

### BACKGROUND OF THE INVENTION

Turbochargers are a type of forced induction system. They deliver air, at greater density than would be possible in the normally aspirated configuration, to the engine intake, allowing more fuel to be combusted, thus boosting the engine's horsepower without significantly increasing engine weight. A smaller turbocharged engine, replacing a normally aspirated engine of a larger physical size, will reduce the mass and can reduce the aerodynamic frontal area of the vehicle.

An example of a typical turbocharger (10) is shown in FIG. 1. The turbocharger (10) uses the exhaust flow from the engine exhaust manifold to drive a turbine wheel (12), which is located in a turbine housing (14). Once the exhaust gas has passed through the turbine wheel (12) and the turbine wheel (12) has extracted energy from the exhaust gas, the spent exhaust gas exits the turbine housing (14) through an exducer and is ducted to the vehicle downpipe and usually to after-treatment devices such as catalytic converters, particulate traps, and NOₓ traps.

In a wastegated turbocharger, the turbine volute is fluidly connected to the turbine exducer by a bypass duct. Flow through the bypass duct is controlled by a wastegate valve (16). Because the inlet of the bypass duct is on the inlet side of the turbine volute, which is upstream of the turbine wheel (12), and the outlet of the bypass duct is on the exducer side of the volute, which is downstream of the turbine wheel (12), flow through the bypass duct, when in the bypass mode, bypasses the turbine wheel (12), thus not adding to the power extracted by the turbine wheel. To operate the wastegate, an actuating or control force must be transmitted from outside the turbine housing (14), through the turbine housing (14), to the wastegate valve (16) inside the turbine housing (14). To that end, a wastegate pivot shaft (18) extends through the turbine housing (14).

An actuator (20) is provided external to the turbine housing (14). The actuator (20) is connected to a wastegate lever arm (22) via a linkage (24), and the wastegate lever arm (22) is connected to the wastegate pivot shaft (18). Inside the turbine housing (14), the pivot shaft (18) is connected to the wastegate valve (16). Actuating force from the actuator (20) is translated into rotation of the pivot shaft (18), which moves the wastegate valve (16) inside of the turbine housing (14). In some instances, the wastegate pivot shaft (18) rotates in a cylindrical bushing (26) provided within a bore (28) in the turbine housing (14). In other instances, the wastegate pivot shaft (18) rotates within a bore in the turbine housing (14) without a bushing.

Turbine housings (14) experience great temperature flux during the operation of the turbocharger (5). The outside of the turbine housing (14) is exposed to ambient air temperature while the turbine volute surfaces contact exhaust gases ranging from 740° C. to 1050° C., depending on the fuel used in the engine. Thus, it is essential that the actuator (20) be able to control the wastegate valve (16) to thereby control flow to the turbine wheel (12) in an accurate, repeatable, non jamming manner.

Further, there is an annular clearance (34) between the outer peripheral surface (30) of the pivot shaft (18) and the inner peripheral surface (32) of the bore in the bushing (26), in which it is located. An escape of hot, toxic exhaust gas and soot from the pressurized turbine housing (14) is possible through this clearance. Soot deposits are unwanted from a cosmetic standpoint, and the escape of exhaust gas containing CO, CO₂, and other toxic chemicals can be a health hazard to the occupants of the vehicle. This makes exhaust leaks a particularly sensitive concern in vehicles such as ambulances and buses. From an emissions standpoint, the gases which escape from the turbine stage are not captured and treated by the engine/vehicle aftertreatment systems.

Many efforts have been made to minimize the passage of exhaust gas and soot through the clearance (34). For instance, seal means, such as seal rings (also called piston rings) have been used. Referring to FIG. 2, a seal ring (36) is provided between the pivot shaft (18) and the bushing (26). The seal ring (36) can seal against the inner peripheral surface (32) of the bushing (26) and the shaft (18). The seal ring (36) can partly reside within a ring groove (38) provided in the shaft (18).

While the ring seal (36) can minimize the passage of exhaust gas and soot (40) to some degree, a substantially complete sealing condition may be achieved only when the seal ring directly contacts a sidewall (42, 44) of the seal ring groove (38). However, most conditions, a leakage path as generally depicted in FIG. 2 can exist. While there have been numerous efforts to reduce this leakage by providing a plurality of ring seals and by modifying the pressure differential across the plurality of seal rings by introducing a pressure or vacuum between the rings, but potential leakage always exists unless the seal rings (36) are in direct contact with the side wall(s) (42, 44) of the groove (38).

Thus, there is a need for an effective sealing system to minimize the passage of exhaust gas and soot in a turbocharger.

### SUMMARY OF THE INVENTION

Embodiments described herein can provide an effective sealing system for a turbocharger in the interface between a rotatable element and a surrounding structure, such as at the interface a pivot shaft is received in the turbine housing of a wastegated or VTG turbocharger. The sealing system can introduce a spring loaded, self-centering, complementary pair of narrowing sealing surfaces, which can be frusto-spherical or frusto-conical in conformation. The spring pressure can force the pair of complementary sealing surfaces together producing sealing contact and maintain such contact. Thus, a continuous gas and soot seal between a chamber internally pressurized with exhaust gas and soot and the environment outside can be achieved.

### BRIEF DESCRIPTION OF THE DRAWINGS

The present invention is illustrated by way of example and not limitation in the accompanying drawings in which like reference numbers indicate similar parts, and in which:

FIG. 1 is a cross-sectional view of a typical wastegate turbocharger;

FIG. 2 is a section view of an interface between a shaft and a bushing in a typical turbocharger, showing, a gas leakage path;

FIGS. 3A-B is a cross-sectional view of a first embodiment of a sealing system;

FIG. 4A is a cross-sectional view of a second embodiment of a sealing system, wherein a non-rigid connection is provided between an insert and a shaft;

FIG. 4B is a cross-sectional view of the second embodiment of a sealing system, wherein a rigid connection is provided between the insert and the shaft;

FIG. 5 is a cross-sectional view of an alternative configuration of the second embodiment of a sealing system;

FIG. 6 is a cross-sectional view of a third embodiment of a sealing system;

FIG. 7 is a cross-sectional view of an alternative arrangement in which the sealing surfaces of the sealing system are frusto-conical; and

FIG. 8 is a cross-sectional view of an alternative arrangement in which the sealing system includes a piston ring.

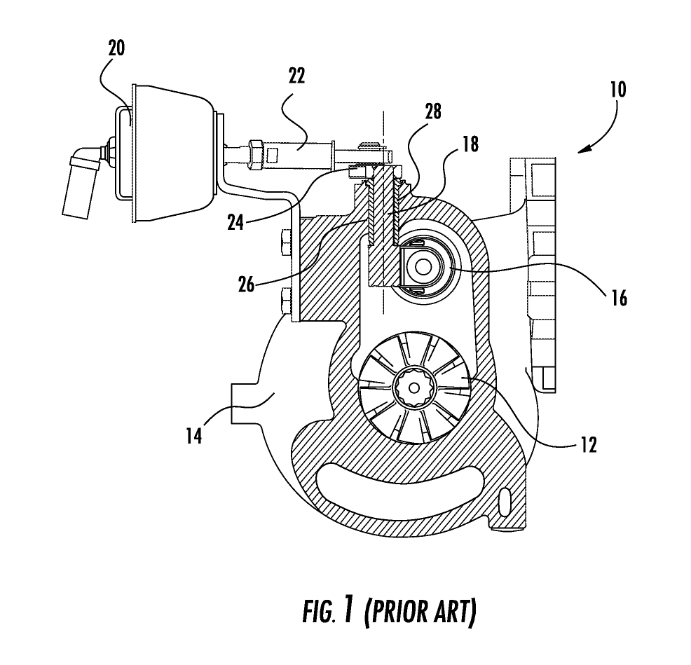

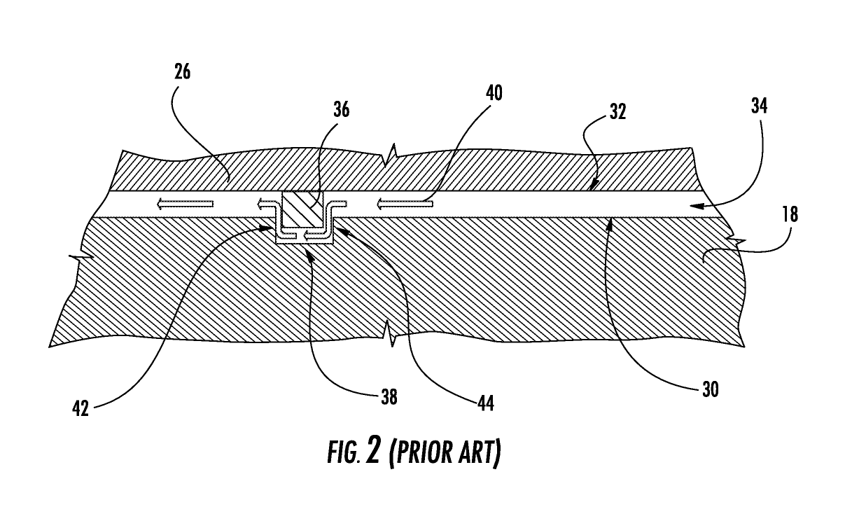

### DETAILED DESCRIPTION OF THE INVENTION

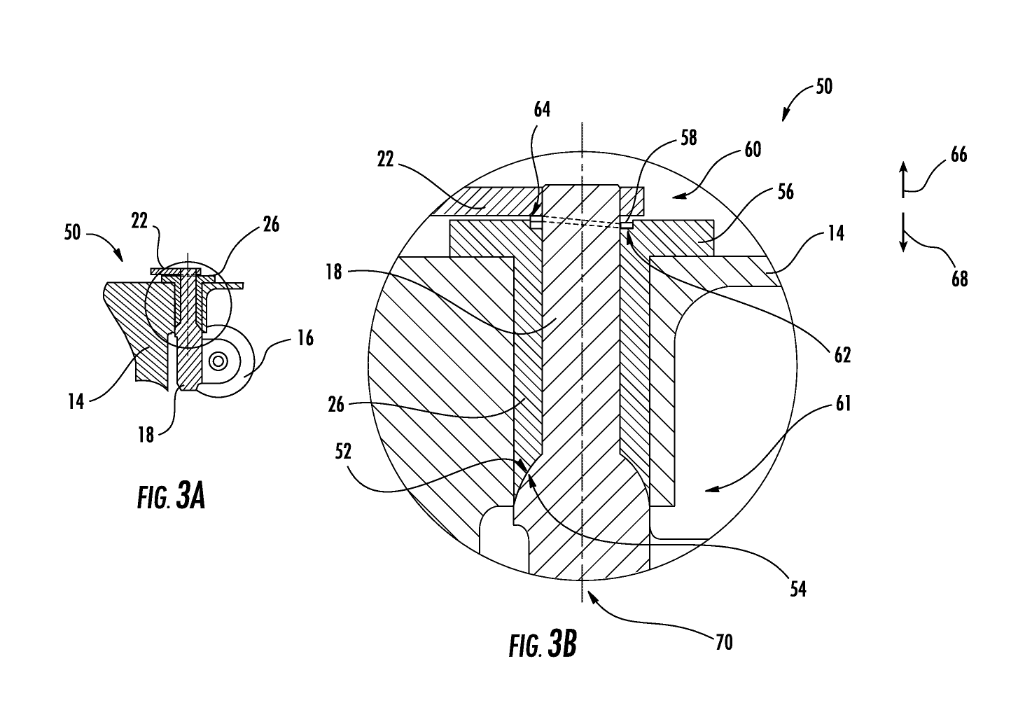

Arrangements described herein relate to device turbocharger having an improved sealing system for the interface between a shaft and a surround structure (e.g., between a pivot shaft and a pivot shaft bushing). Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Arrangements are shown in FIGS. 3-8, but the embodiments are not limited to the illustrated structure or application.

Embodiments are directed to the use of complementary narrowing sealing surfaces provided on a rotatable or movable element (e.g., a shaft, the pivot shaft or an element provided on a pivot shaft) and a surrounding structure (e.g., the pivot shaft bushing) and along with a system for maintaining engagement of these sealing surfaces during operation of the turbocharger.

The narrowing sealing surfaces can have any suitable form. Generally, the diameter or width of the narrowing sealing surfaces can decrease along the length of the shaft or rotatable element. In one embodiment, one sealing surface can include a region of narrowing concavity, and the other sealing surface can have a complementary region of narrowing convexity.

Examples of suitable narrowing sealing surfaces can include surfaces that are generally frusto-conical, frusto-spherical, part conical, part spherical, stepped, even combinations of flat and conical or flat and spherical, or combinations of differently angled conical surfaces or combinations of different curvature surfaces used in the interface of shaft and bushing. The conical surfaces can be provided at any suitable angle, and the curvature surfaces can be provided at any suitable curvature. The narrowing sealing surfaces can be substantially concentric with the shaft axis. These and other narrowing sealing surfaces are described in WO2011/149867 A2, the disclosure of which is incorporated herein by reference.

The following discussion will be described in connection with an interface between a rotating element (e.g., a wastegate pivot shaft, or a VTG control shaft) and a surrounding structure (e.g. a bushing or the turbine housing). However, it will be understood that embodiments described herein can be used in any suitable location in a turbocharger in which a rotating element is received at least partially within another structure.

An example of a first embodiment of a shaft sealing system (50) is shown in FIGS. 3A-3B. The system (50) can include a complementary pair of narrowing sealing surfaces (52, 54) provided on the pivot shaft (18) and the bushing (26). While the sealing surfaces (52, 54) are shown as being frusto-conical, it will be appreciated that the sealing surfaces (52, 54) can have any suitable configuration, some examples of which are described above. The sealing surfaces (52, 54) are referred to as “frusto” conical or “frusto” spherical since the peak of the shape would be in the area occupied by the pivot shaft (18), and thus, would be “cut off” This frusto-conical interface can prevent the pivot shaft (18) from rocking and tilting on the bushing (26) while centering the shaft (18) in the bushing (26).

The bushing (26) can be axially constrained by a flange (56). The bushing (26) can be constrained axially and angularly by a pin (not shown) inserted between an outside diameter of the pivot shaft bushing (26) and the turbine housing (14), or it can be axially constrained by mechanical engagement and/or by other suitable means toward the inner end of the bushing (26).

In one embodiment, the sealing surface (54) can be defined by the shaft (18) itself, as is shown in FIG. 3A-3B. In such case, the feature can be formed into the shaft (18), such as by machining Alternatively, the sealing surface (18) can be defined by a separate element (not shown) that can be rigidly attached to the shaft (18), such as by press fit, mechanical engagement, fasteners, adhesives and/or other suitable attachment means. While FIG. 3 shows the sealing surface (54) on the shaft as being convex frusto-conical and the sealing surface (52) provided on the bushing (26) as being concave frusto-conical, it will be appreciated that the opposite arrangement could be provided, that is, a convex frusto-conical sealing surface can be provided on the bushing (26) and a concave frusto-conical sealing surface can be provided on the shaft (18).

The system (50) can further include a biasing element. As an example, the biasing element can be a spring (58). The spring (58) can be any suitable type of spring, such as a helical spring or a wave spring. In the arrangement shown in FIGS. 3A and B, the spring (58) can be operatively positioned between a structure surrounding a portion of the shaft (18) and a structure attached to an outer end region (60) of the shaft (18). For instance, the spring (58) can be operatively positioned between the pivot shaft bushing (26) and the lever arm (22) attached to the end region (60) of the shaft (18). The lever arm (22) can be operatively connected to the shaft (18) in any suitable manner, such as by one or more fasteners, mechanical engagement, adhesives, welding, and/or other means. The term “operatively connected,” as used herein, can include direct or indirect connections, including connections without direct physical contact. The terms “outer” and “inner” are used with respect to the pivot shaft (18) for convenience to note the general position of a portion of the shaft (18) relative to the wastegate valve (16) or other element that movement of the shaft (18) directly or indirectly affects. Thus, an “inner” portion of the shaft (18) is located closer to the wastegate valve (16) than an “outer” portion of the shaft (18).

The spring (58) can operatively engage an outward-facing surface (62) on the pivot shaft bushing (26) and a bushing-facing surface (64) of the lever arm (22). Thus, the spring (58) can exert a force generally in a second direction (68) on the outward facing surface (62) of the pivot shaft bushing (26). The spring (58) can simultaneously exert a force in a first direction (66) on the surface (64) of the lever arm (22). The first direction 66 can be opposite to the second direction 68. Consequently, the sealing surface (52) can be pushed in the second direction (68) (that is, downward in the arrangement shown in FIG. 3B) due to the force of the spring (58). The sealing surface (54) can be pulled in the first direction (66) (that is, upward in the arrangement shown in FIG. 3B), as the lever arm (22) is being pushed in the first direction (66) by the spring (58), thereby pulling the operatively connected pivot shaft (18) with it. Thus, the complementary pair of sealing surfaces (52, 54) can be brought together by the reaction of a spring (58), thereby producing a seal to prevent a flow of gas and soot from escaping the turbine housing (14) to the environment. Such a seal can be maintained by the continued force exerted by the spring (58).

The self-centering action of the spring (58) with the pair of sealing surfaces (52, 54) can pull the pivot shaft (18) substantially into concentricity with the desired axis of rotation about the axis (70), resisting the cocking action caused by the seat pressure requirement of the actuator. As a result, the overlap of the wastegate valve face with the wastegate port, against which it seals, can be smaller, resulting in the opportunity to reduce the size of the wastegate valve head.

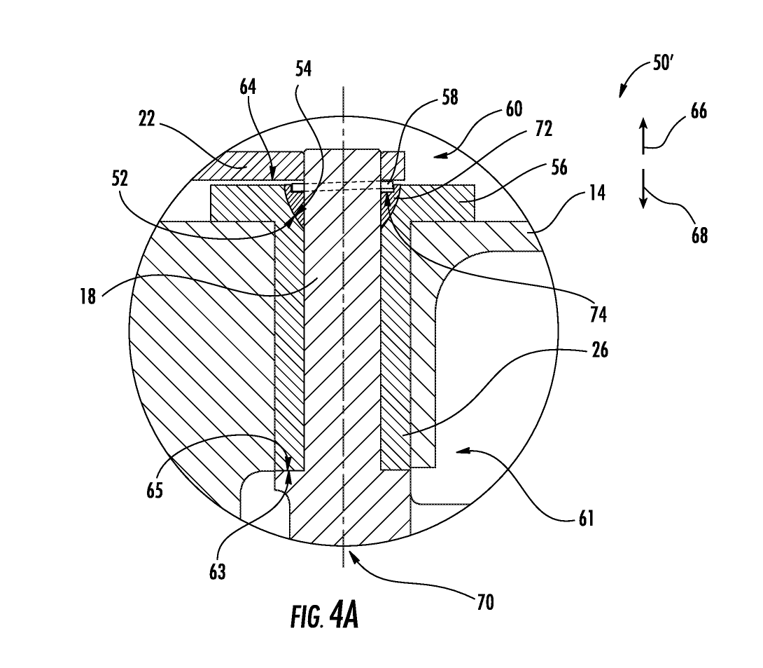

A second embodiment of a shaft sealing system (50′) is shown in FIGS. 4A-B. In this embodiment, the pair of complementary narrowing sealing surfaces (52, 54) can be located toward the outside of the wastegate pivot shaft (18) to create an “outer seal”. The above description of the sealing surfaces (52, 54) above is equally applicable to system (50′). The sealing surface (54) on the shaft (18) can be convex frusto-conical and the sealing surface (52) provided on the bushing (26) can be concave frusto-conical. The sealing surface (54) can be defined by the shaft (18). However, in some instances, such an arrangement may not be possible or practical. For instance, because the lever arm (22) is typically assembled in a direction from the inside of the turbine housing (14), toward the outside of the turbine housing (which is toward the top of the page in the depiction of FIG. 4A), the sealing surface (54) can be provided on a separate insert (72) that is assembled to the wastegate pivot shaft (18) after the pivot shaft (18) is inserted into the bushing (26) in which it resides.

The insert (72) can be attached to the shaft (18) in any suitable manner, including, for example, in a non-rigid manner so that the shaft (18) can move relative to the insert (72), including along the direction of axis (70). However, in other instances, the insert (72) can be rigidly attached to that shaft (18). “Rigidly attached” means that the insert (72) is formed with the shaft (18) or the insert (72) is attached to the shaft (18) such that the shaft (18) and insert (72) do not substantially move relative to each other at least in the direction of axis (70), that is, they move together at least in the direction of axis (70). Examples of rigid attachment can include, for example, press fit, mechanical engagement, fasteners, adhesives and/or other suitable attachment means.

The insert (72) can be made of any suitable material. For instance, the insert (72) can be made of a high temperature resistant metal that is compatible with the shaft (18) and/or the bushing (26) from at least tribological and/or galvanic corrosion standpoints.

The system (50′) can further include a biasing element. As an example, the biasing element can be a spring (58). The spring (58) can be any suitable type of spring, such as a helical spring or a wave spring. In the arrangement shown in FIG. 4A, the spring (58) can be operatively positioned between the insert (72) (or even the shaft (18) itself if the sealing surface (54) is provided on the shaft (18)) and a structure attached to an outer end region (60) of the shaft (18), such as the lever arm (22). Such an arrangement may be suitable for instances in which the insert (72) is non-rigidly attached to the shaft (18), such as by a slip fit. In a non-rigid arrangement, the shaft (18) and the insert (72) can move relative to each other at least in the direction of axis (70).

The spring (58) can operatively engage an outward-facing surface (74) on the insert (72) or shaft (18) as well as the bushing facing surface (64) of the lever arm (22). Thus, the spring (58) can exert a force in a first direction (66) on the surface (64) of the lever arm (22). The spring (58) can simultaneously exert a force generally in the second direction (68) on the outward-facing surface (74) on the insert (72). Consequently, the sealing surface (54) can be pushed in the second direction (68) (that is, downward in the arrangement shown in FIG. 4A) due to the force of the spring (58). The sealing surface (52) provided on the bushing (26) can be pulled in the first direction (66) (that is, upward in the arrangement shown in FIG. 4A), as the lever arm (22) is being pushed in the first direction (66) by the spring (58), thereby pulling the operatively connected pivot shaft (18) with it. The pivot shaft (18) can in turn pull the bushing (26) due to engagement between the bushing (26), such as an end surface (65) thereof, and the shaft (18) (e.g., shoulder surface (63)). Thus, the complementary pair of sealing surfaces (52, 54) can be brought together by the reaction of a spring (58), thereby producing a seal to prevent a flow of gas and soot from escaping the turbine housing (14) to the environment. Such a seal can be maintained by the continued force exerted by the spring (58).

In embodiments in which the insert (72) is formed with the shaft (18) or attached to the shaft (18) in a rigid manner, as described above, the spring (58) or other biasing element can be operatively positioned in an interface between the shaft (18) (or other structure connected to the shaft (18)) and an end surface (65) of the bushing (26). An example of such an arrangement is shown in FIG. 4B.

In such case, the spring (58) can exert a force generally in the first direction (66) on the end (65) of the bushing (26), pushing its sealing surface (52) in the first direction (66). The spring (58) can simultaneously exert a force in a second direction (68) on the shaft (18) (or other structure connected to the shaft (18). As an example, the spring (58) can exert a force of the shoulder surface (63) of the shaft (18). The shoulder surface (63) can include a recess (67) to receive the spring (58). Consequently, the sealing surface (54) can be pulled in the second direction (68), that is, downward in the arrangement shown in FIG. 4B due to the force of the spring (58) upon the shat (18) rigidly attached to the insert (72). Thus, a seal is produced and maintained between the complementary pair of sealing surfaces (52, 54).

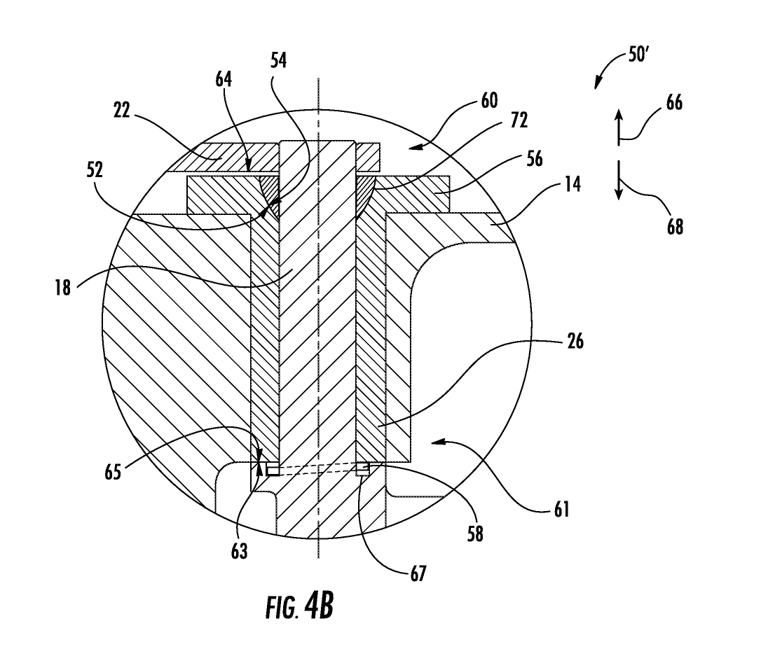

Another example of a sealing system is shown in FIG. 5. In such an arrangement, the intersection of the frusto-spherical surface (52) with the inside diameter of the insert (72) can be cut short to produce a flat surface (76). The flat surface (76) can be generally transverse to the axis of rotation (70). In one embodiment, the flat surface (76) can be substantially perpendicular to the axis (70). An abutment landing (78) can be formed on the shaft (18), such as by a reduction in outer diameter of the shaft (18), as is shown in FIG. 5. In this arrangement, a first spring (58) can be operatively positioned between the insert (72) (or even the shaft (18) itself if the sealing surface (54) is provided on the shaft (18)) and a structure attached to the shaft (18) (e.g., the lever arm (22)). In addition, a second spring (58′) or other biasing element can be operatively positioned between the shaft (18) (or other structure connected to the shaft (18)) and the end surface (65) of the bushing (26). For instance, the second spring (58′) can operatively engage a shoulder surface (63) of the shaft (18). Again, the shoulder surface (63) can include a recess (67).

The first spring (58) can operatively engage the lever arm (22) and the insert (72). Thus, the first spring (58) can exert a force generally in a first direction (66) on the lever arm (22). The first spring (58) can also exert a force generally in the second direction (68) on the insert (72). Thus, the sealing surface (54) and the flat surface (76) can be pushed in the second direction (68) (that is, downward in the arrangement shown in FIG. 5) due to the force of the spring (58).

The second spring (58′) or other biasing element can be operatively positioned between the shoulder surface (63) of the shaft (18) (or other structure connected to the shaft (18)) and an end surface (65) of the bushing (26). In such case, the second spring (58′) can exert a force generally in the first direction (66) on the end (65) of the bushing (26), pushing its sealing surface (52) in the first direction (66) (that is, upward in the arrangement shown in FIG. 5).

The force exerted by the first spring (58) can push the insert (72) inward facing flat surface (76) and the abutment landing (78) of the shaft (18) toward each other and into contact with each other. Such contact between the flat surface (76) and the abutment landing (78) can result in substantially sealing engagement, thereby producing an additional sealing interface between the shaft (18) and the insert (72) to minimize soot and gas leakage. The sealing interface can be maintained by the force exerted by the first spring (58).

Further, the force exerted by the first spring (58) can push the sealing surface (54) in the second direction (68), and force exerted by the second spring (58′) can push the sealing surface (52) in the first direction (66). As a result, the surfaces (52, 54) can be brought into substantially sealing contact with each other. The substantially sealing contact between the surfaces (52, 54) can be maintained by the first and second springs (58, 58′).

It should be noted that, in some instances, the insert (72) can be clamped in place such that the flat surface (76) and the abutment landing (78) directly abut each other. Such an arrangement can be maintained by welding the lever arm (22) to the shaft (18). In such case, the sealing surfaces (52, 54) can be brought into contact and maintained in contact by the second spring (58′) such that the first spring (58) may not be needed.

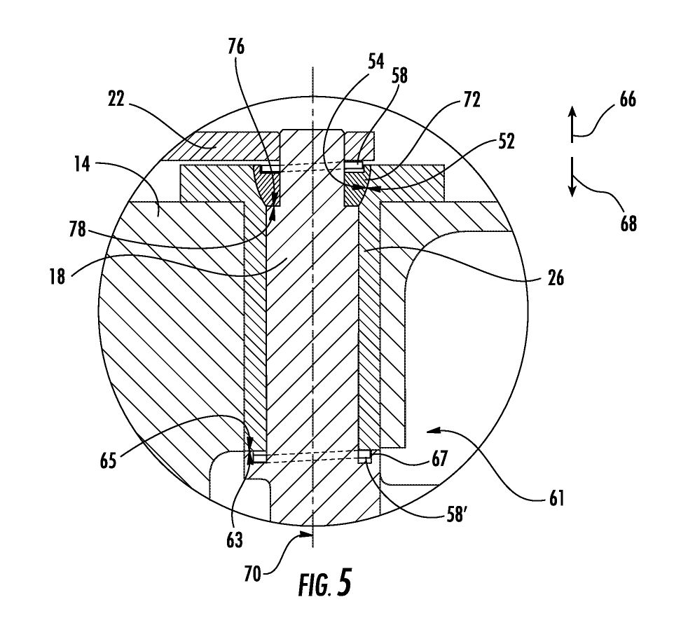

A third embodiment of a shaft sealing system (50″) is shown in FIG. 6. In this embodiment, the pairs of complementary frusto-spherical surfaces are provided in two locations to form an “inner seal” and an “outer seal.” As an example, FIG. 6 shows one possible combination of aspects shown in FIGS. 3A-B and 4. The spring (58) can operatively engage the insert (72) or shaft (18) as well as the lever arm (22). Thus, the spring (58) can exert a force in a first direction (66) on the lever arm (22). The spring (58) can simultaneously exert a force generally in the second direction (68) on the insert (72). Consequently, the outer sealing surface (54) can be pushed in the second direction (68) (that is, downward in the arrangement shown in FIG. 6) due to the force of the spring (58). The outer sealing surface (52) can be pulled in the first direction (66) (that is, upward in the arrangement shown in FIG. 6), as the lever arm (22) is being pushed in the first direction (66) by the spring (58), thereby pulling the operatively connected pivot shaft (18) and bushing (26) with it. Thus, the complementary pair of sealing surfaces (52, 54) can be brought together by the reaction of a spring (58), thereby producing a seal to prevent a flow of gas and soot from escaping the turbine housing (14) to the environment. Such a seal can be maintained by the continued force exerted by the spring (58).

In this arrangement, the force exerted by the spring (58) can pull the inner convex frusto-spherical surface (54′) into the inner concave frusto-spherical surface (52′). The force exerted by the spring (58) can also push the insert (72) inward (that is, downward in FIG. 6), thereby forcing the outer convex frusto-spherical surface (54′) into the outer concave frusto-spherical surface (54′), thus providing twin centering mechanisms and twin sealing interfaces. The arrangement shown in FIG. 6 is suitable for embodiments in which the insert (72) is non-rigidly attached (e.g., slip fit) to the shaft (18).

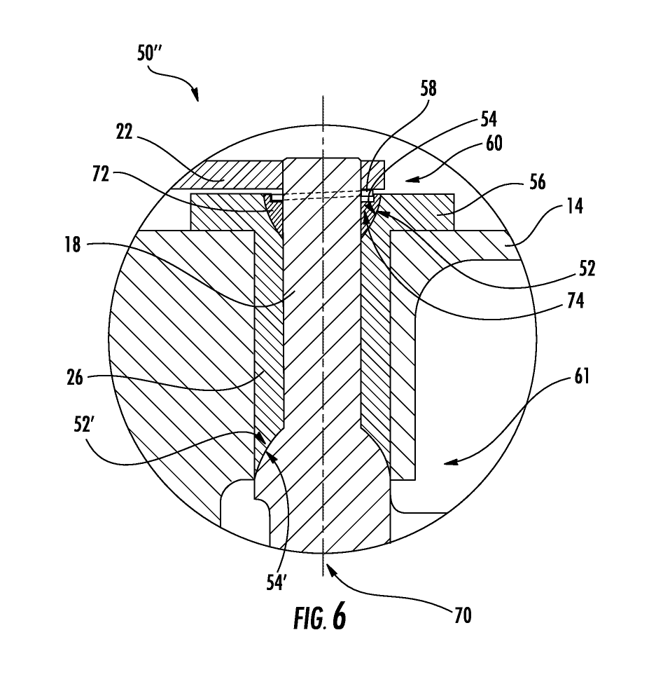

As noted above, the complementary narrowing sealing surfaces (52, 54) can have any suitable configuration. Thus, while the sealing surfaces are shown in FIGS. 3-6 as being frusto-spherical surfaces, it will be understood that embodiment are not limited to frusto-spherical sealing surfaces. Indeed, FIG. 7 shows an alternative arrangement in which the sealing surfaces are configured as frusto-conical surfaces. In this configuration, an insert (72) containing a frusto-conical sealing surface (54) is pushed into a complementary frusto-conical sealing surface (52) in the bushing (26), thereby centering the insert (72) and shaft (18) in the bushing (26) and providing a sealing interface to prevent the passage of soot and gas from inside the turbine housing to the environment.

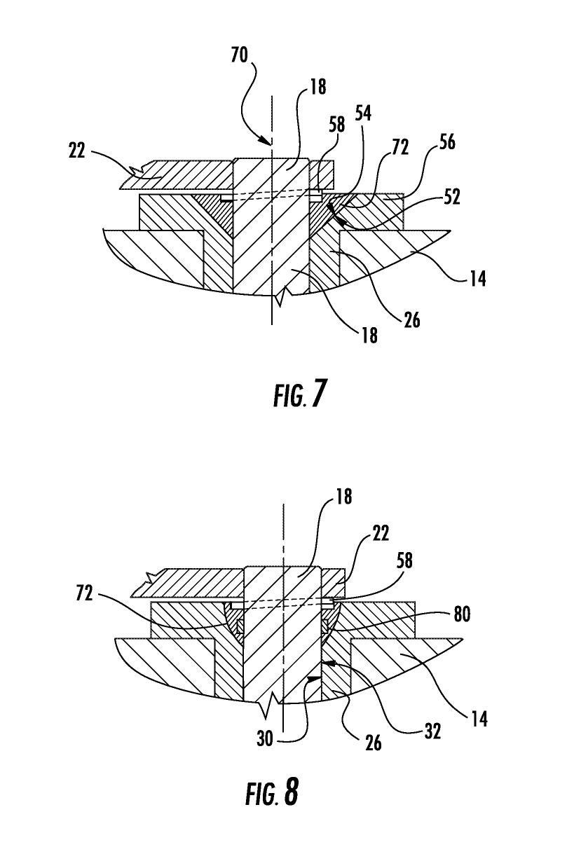

FIG. 8 presents a further alternative arrangement of the sealing system. One or more ring seals, such as piston ring (80), can be used to seal the leakage path between the inside diameter of the bores in the insert (72) and the outer peripheral surface (30) of the pivot shaft (18).

It will be appreciated that the above arrangements can provide an effective sealing system. By providing a spring, the seal can be maintained under substantially all turbocharger operational conditions. Thus, the sealing systems are not dependent on operational conditions (e.g., turbine housing pressure) to hold the sealing surfaces together. Further, the sealing systems presented herein can tolerate misalignment of the operative components to a much greater degree than piston ring seal systems used in the past. The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

Aspects described herein can be embodied in other forms and combinations without departing from the spirit or essential attributes thereof. Thus, it will of course be understood that embodiments are not limited to the specific details described herein, which are given by way of example only, and that various modifications and alterations are possible within the scope of the following claims.

1. A sealing system (50) for a turbocharger comprising:
a rotatable element including a shaft (18) having an associated axis of rotation (70), an inner portion (61) and an outer portion (60);
a structure operatively connected to the outer portion (60) of the shaft (18);
a structure having a bore, at least a portion of the rotatable element being received within the bore;
a pair of complementary narrowing sealing surfaces (52, 54), one of the sealing surfaces (54) being provided on the inner portion (61) of rotatable element and the other sealing surface (52) being provided on the structure having a bore;
a biasing element (58) operatively positioned between the structure having a bore and the structure operatively connected to the outer portion (60) of the shaft (18), the biasing element (58) exerting a force on the structure operatively connected to the outer portion (60) of the shaft (18) in a first direction (66), and the biasing element (58) further exerting a force on the structure having a bore in a second direction (68) opposite to the first direction (66), whereby the sealing surfaces (52, 54) are brought into engagement with each other to form a seal.

2. The sealing system of claim 1, wherein the shaft (18) is a VTG or wastegate pivot shaft (18), and the structure attached to the shaft (18) is a lever arm (22).

3. The sealing system of claim 1, wherein the structure having a bore is a bushing (26).

4. The sealing system of claim 1, wherein the structure having a bore is a turbine housing (14) or a bearing housing.

5. The sealing system of claim 1, wherein the narrowing sealing surfaces (52, 54) are frusto-conical.

6. The sealing system of claim 1, wherein the narrowing sealing surfaces (52, 54) are frusto-spherical.

7. The sealing system of claim 1, wherein rotatable element includes an insert (72) operatively connected to the shaft (18), and wherein the sealing surface provided on the inner portion (61) of rotatable element is defined by the insert (72).

8. The sealing system of claim 1, wherein the sealing surface provided on the inner portion (61) of shaft (18) is defined by the shaft (18).

9. A sealing system (50′) for a turbocharger comprising:
a rotatable element including a shaft (18) having an associated axis of rotation (70), an inner portion (61) and an outer portion (60);
a structure operatively connected to the outer portion (60) of the shaft (18);
a structure having a bore, at least a portion of the rotatable element being received within the bore;
a pair of complementary narrowing sealing surfaces (52, 54), one of the sealing surfaces (54) being provided on the outer portion (60) of rotatable element and the other sealing surface (52) being provided on the structure having a bore;
a biasing element (58) operatively positioned between the rotatable element and the structure operatively connected to the outer portion (60) of the shaft (18), the biasing element (58) exerting a force on the structure operatively connected to the outer portion (60) of the shaft (18) in a first direction (66), and the biasing element (58) further exerting a force on the rotatable element in a second direction (68) opposite to the first direction (66), whereby the sealing surfaces (52, 54) are brought into engagement with each other to form a seal.

10. The sealing system of claim 9, wherein the shaft (18) is a VTG or wastegate pivot shaft (18), and the structure attached to the shaft (18) is a lever arm (22).

11. The sealing system of claim 9, wherein the structure having a bore is one of a bushing (26) or a turbine housing (14).

12. The sealing system of claim 9, wherein the narrowing sealing surfaces (52, 54) are frusto-conical.

13. The sealing system of claim 9, wherein the narrowing sealing surfaces (52, 54) are frusto-spherical.

14. The sealing system of claim 9, wherein rotatable element includes an insert (72) operatively connected to the shaft (18), and wherein the sealing surface provided on the outer portion (60) of rotatable element is defined by the insert (72).

15. The sealing system of claim 9, wherein the sealing surface provided on the outer portion (60) of rotatable element is defined by the shaft (18).

16. A sealing system for a turbocharger comprising:
a rotatable element including a shaft (18) having an associated axis of rotation (70), an inner portion (61) and an outer portion (60);
a structure operatively connected to the outer portion (60) of the shaft (18);
a structure having a bore, at least a portion of the rotatable element being received within the bore;
a first pair of complementary narrowing sealing surfaces (52′, 54′), one of the sealing surfaces (54′) being provided on the inner portion (61) of rotatable element and the other sealing surface (52′) being provided on the structure having a bore;
a second pair of complementary narrowing sealing surfaces (52, 54), one of the sealing surfaces (54) being provided on the outer portion (60) of rotatable element and the other sealing surface (52) being provided on the structure having a bore;
a biasing element (58) operatively positioned between the rotatable element and the structure operatively connected to the outer portion (60) of the shaft (18), the biasing element (58) exerting a force on the structure operatively connected to the outer portion (60) of the shaft (18) in a first direction (66), and the biasing element (58) further exerting a force on the rotatable element in a second direction (68) opposite to the first direction (66), whereby the first pair sealing surfaces (52′, 54′) are brought into engagement with each other to form a first seal and whereby the second pair sealing surfaces (52, 54) are brought into engagement with each other to form a second seal.
